(19) United States
(12) Patent Application Publication
(10) Pub. No.: US 2015/0009522 A1
(43) Pub. Date: Jan. 8, 2015

(54) SELECTION OF A CONFIGURATION LINK TO RECEIVE ACTIVATION DATA

(71) Applicants: Fernando Luis Caprio da Costa Junior, Porto Alegre (BR); Deny Joao Correa Azzolin, Porto Alegre (BR)

(72) Inventors: Fernando Luis Caprio da Costa Junior, Porto Alegre (BR); Deny Joao Correa Azzolin, Porto Alegre (BR)

(73) Assignee: HEWLETT-PACKARSD DEVELOPMENT COMPANY, L.P., Houston, TX (US)

(21) Appl. No.: 14/372,687

(22) PCT Filed: Jan. 31, 2012
(86) PCT No.: PCT/US2012/023329

§ 371 Date: Jul. 16, 2014

(51) Int. Cl. G06F 3/12

(52) U.S. Cl. CPC G06F 3/1253; G06F 3/1286; G06F 3/1238; G06F 3/1231
USPC 358/1.14

(57) ABSTRACT

Examples disclose a processor to launch an application based on a selection of a configuration link associated with a token. Further, the examples provide the application to receive the token which is associated with a server and a unique identifier. Additionally, examples disclose the application transmits the unique identifier to the server associated with the token and based on an authentication of the unique identifier at the server, the application receives activation data.

### BACKGROUND

Printing applications enable users of mobile devices to print by connecting to a printer through contacting a server in a network. However, in order to contact the server, the user of the mobile device may need to manually configure properties, such as the server name and/or address in the printing application. Additionally, the printing application may require a specific type mobile device provided by the network.

### BRIEF DESCRIPTION OF THE DRAWINGS

In the accompanying drawings, like numerals refer to like components or blocks. The following detailed description references the drawings, wherein:

FIG. 1 is a block diagram of an example computing device including a processor launching an application based on a selection of a configuration link associated with a token, the application to transmit a unique identifier to a server and receives activation data;

FIG. 2 is a block diagram of an example computing device including a processor to launch an application based on a selection of a configuration link associated with a token, the application to transmit a unique identifier and receive activation data from a server that generates the unique identifier, and a memory to store the activation data;

FIG. 3 is a communication diagram of receiving an email with a configuration link and transmitting activation data between a server and a computing device, the computing device including a communication platform, a processor, and a memory;

FIG. 4 is a block diagram of an example computing device including a processor to receive an email with a configuration link, receive activation data, and store the activation data; and

FIG. 5 is a flowchart of an example method performed on a computing device to launch an application based on a selection of the configuration link, the application to transmit a unique identifier to a server, and receive activation data from the server.

### DETAILED DESCRIPTION

Printing applications may be configured to specific network printers allowing a user access to print from their mobile device. As such, the printing application needs to be manually configured and authenticated in order to submit print jobs to each server. Each network uses a different server configuration. In order to configure the printing application to the specific server, the user may need to input the server properties which require much technical knowledge from the user. Further still, the printing applications may be configured for specific networks. For example, a network provider may authorize only those devices provided by that network provider. As such, the printing application may be configured for specific devices within those specific provider networks.

To address these issues, example embodiments disclosed herein include a computing device with a processor to launch an application based on a selection of a configuration link which is associated with a token. The token, associated with a server and a unique identifier, is received by the application. The application then transmits the unique identifier to the server for authentication. Once the server authenticates the unique identifier, the server transmits an activation data to the application. Launching the application based on the configuration link selection and receiving the token is a more user-friendly approach to configuring and authenticating the application as this is done on the background without requiring the user to manually configure the application.

Additionally, in the various examples disclosed herein, the token received by the application is an encrypted token and this encrypted token may be decrypted. In this embodiment, the application and/or computing device may include a decryption technique local to the application and/or computing device to decrypt the encrypted token. This provides an additional security feature to prevent any unauthorized devices from configuring and authenticating the application based on the selection of the configuration link.

In one embodiment, the computing device also includes a communication platform to receive the configuration link in an email. In this embodiment, the configuration link for configuring the application is enabled by email rather than over a specific network. This allows different types of mobile devices over various network providers to configure and authenticate the application.

In another embodiment, the activation data from the server includes a policy restriction. In a further embodiment, the activation data is stored on a memory of the computing device. In these embodiments, the policy restriction may be specific to the user of the mobile device and stored on the memory for further access when the user desires to print. For example, the policy restriction may only authorize a limited number of print quota and as such, the activation data stored on the memory may track this number. As a further example, the activation data stored on the memory of the computing device may be used for further authentication to the application. In this example, the application need not be authenticated and configured each time the user desires to print.

In this manner, example embodiments disclosed herein provide configuring and authenticating an application based on a selection of a configuration link, thus creating a more-user friendly approach. Additionally, this prevents the user from manually configuring the server properties in the printing application. Further, this allows the printing application to be configured on varying mobile devices provided by various network providers.

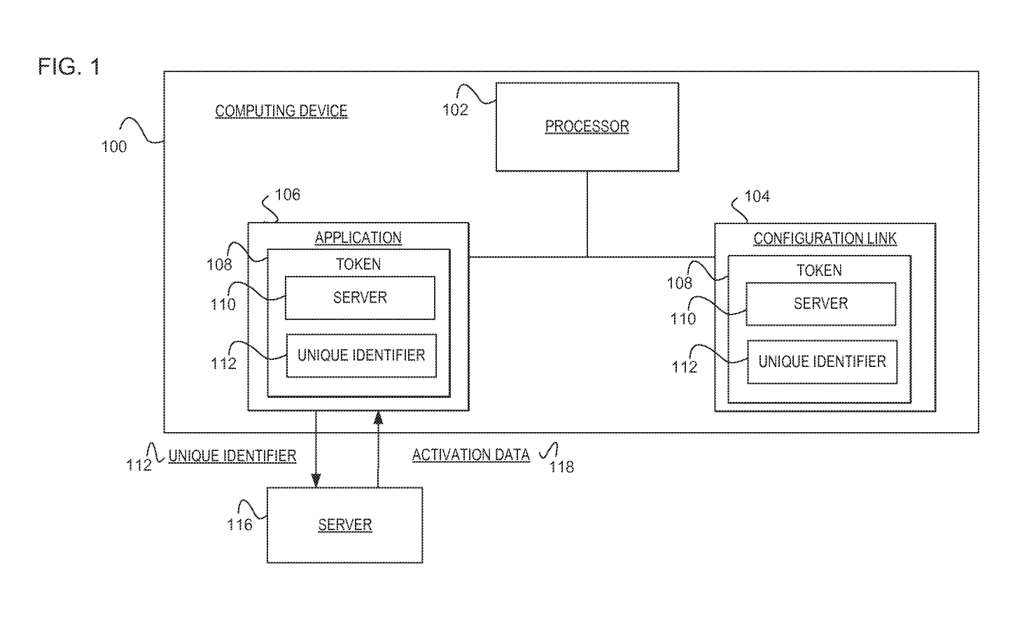

Referring now to the drawings, FIG. 1 is a block diagram of an example computing device 100 including a processor 102 to launch an application 106 based on a selection of a configuration link 104 which includes a token 108. Additionally, the application 106 receives the token 108 associated with a server 110 and a unique identifier 112 and transmits the unique identifier 112 to a server 116. The server 116 authenticates the unique identifier 112 and transmits activation data 118 to the application 106. Embodiments of the computing device 100 include a client device, personal computer, laptop, a mobile device, or other devices suitable to launch the application 106 based on the selection of the configuration link 104 and communicate with server 116.

The processor 102 launches the application 106 based on the selection of the configuration link 104. Embodiments of the processor 102 may include a central processing unit (CPU), visual processing unit (VPU), microprocessor, graphics processing unit (CPU), integrated circuit, or other programmable device suitable to launch the application 106 based on the selection of the configuration link 104.

The configuration link 104, associated with the token 108, is received by the computing device 100 and selected to launch the application 106. The configuration link 104 is a hyperlink received by the computing device 100 that a user may select by a user-initiated response, such as clicking on the configuration link 104 or hovering over the configuration link 104. Specifically, the configuration link 104 references the token 108 that includes data (i.e., the server 110 and the unique identifier 112) used to configure and authenticate the application 106 to the server 116. In this embodiment, the application 106 may be automatically configured and authenticated on the background of the computing device 100. The configuration link 104, once selected, is a type of instruction or code for the processor to launch the application 106. In this manner, the configuration link 104 is associated with the application 106. Further, the configuration link 104 may include the token 108, by referencing the token 108 for the processor 102 to receive from the server 116 or is included as part of the configuration link 104. The computing device 100 receives the configuration link 104 as a communication from the server 116. Embodiments of this communication may include text message, email, instant message, personal message, or other type of communication capable of transmitting the configuration link 104 to the computing device 100. In another embodiment, the configuration link 104 is received in an email by the computing device 100 from the server 116. For example in this embodiment, an administrator at the server 116 may choose to transmit the configuration link 104 in email to a number of users to authorize and configure the application 106 to allow the users printing privileges.

The token 108 is data that represents and/or includes the server 110 and the unique identifier 112 for configuration and authentication of the application 106 to the server 116. The token 108 is received by the application 106 once the application 106 is launched. In this regard, the token 108 is an instruction for the application 106 to transmit the unique identifier 112 to the associated server 110. Embodiments of the token 108 include being transmitted from the server 116 to the application 106 once the application 106 is launched, while in other embodiments, the token 108 is included as part of the configuration link.

The server 110 is associated with the token 108 and references the server 116. The server 110 is data that references the server 116 such that the application 106 may direct a communication exchange with the server 116. In one embodiment, the server 110 is server data that is associated with the server 116. In another embodiment, the server 110 includes at least one of a server address and a server name of the server 116. For example, the token 108 may include the name of server 116 and/or address of server 116. In a further example, the server 110 may include the hostname and/or Internet Protocol (IP) address of server 116. In these embodiments, the application 106 once receiving the token 108 contains the information on where to transmit the unique identifier 112 for authentication. Also, in this embodiment, by including the server 110 which references the server 116, this enables an automatic configuration of the application 106 to determine to which server 116 may grant access to the computing device 100 for printing. Additionally, this prevents the user of the computing device 100 from manually configuring the application 106 with the server 116 properties.

The unique identifier 112 included with the token 108 is transmitted from the application 106 to the server 116 for authentication purposes. The unique identifier 112 is unique reference number used for authentication from the application 106 to the server 116. Embodiments of the unique identifier 112 include a globally unique identifier (GUID), universally unique identifier (UUID), or other unique identifier 112 suitable for authentication purposes from the application 106 to the server 116. In another embodiment, the unique identifier 112 is generated at the server 116.

The application 106, launched by the processor 102, receives the token 108, transmits the unique identifier 112 to the server 116, and receives the activation data 118. The application 106 includes a set of instructions executable by the processor 102 that enable the computing device 100 to perform a task. In an embodiment of the application 106, it may be downloaded onto the computing device 100 prior to the launch, while in another embodiment, the application 106 may be downloaded concurrently with the launch. In a further embodiment, the application 106 is a mobile printing application. Yet, in a further embodiment, the application 106 receives an encrypted token and decrypts the encrypted token. In this embodiment, the encrypted token is decrypted using a decryption technique specific to the application 106 and/or the computing device 100.

The server 116 as identified by the server 110 receives the unique identifier 112 and once establishing the unique identifier 112 as genuine (i.e., authentication), the server 116 transmits the activation data 118 to the application 106. The server 116 provides services across a network and may include, for example, a web server, network server, an enterprise server, a Local Area Network (LAN) server, a print server, or any other computing device suitable to authenticate the unique identifier 112 and transmit the activation data 118. In another embodiment, the server 116 transmits the email with the configuration link 104 to the computing device 100. In this embodiment, the server 116 may include a list of email addresses to transmit the configuration link 104. This enables the application 106 to be configured on varying mobile devices provided by various network providers.

The activation data 118 is transmitted from the server 116 to the application 106 for further access to print. The activation data 118 is data that describes the type of authorization the computing device 100 may have with regards to printing. Further, the activation data 118 includes registering the computing device 100 with the server 116 in order to track any needed updates or changes to the activation data 118. For example, the server 116 may wish to revoke printing privileges and as such, the activation data 118 is tracked in order to revoke these privileges. As a further example, the server 116 may desire to enable the application 106 for the configuration of an additional printer. In an embodiment, the activation data 118 includes a policy restriction. The policy restriction is one or more policy limitations to constrain the computing device 100 and as such may be specific to a user of the computing device 100. For example, the activation data 106 may include a policy restriction that restricts the computing device 100 to specific printers. As a further example, the policy restriction may restrict the computing device 100 to specific file types, such as a spreadsheet of word processing document. In another embodiment, the activation data 118 is stored on a memory within the computing device 100. In this embodiment, when the application 106 is again launched, the activation data 118 may be transmitted to the server 116 to authorize the application 106 to print rather than needing to repeat the configuration and authentication. Once the activation data 118 is received the by application 106, the user of the computing device 100 can proceed to submit print jobs to the server 116.

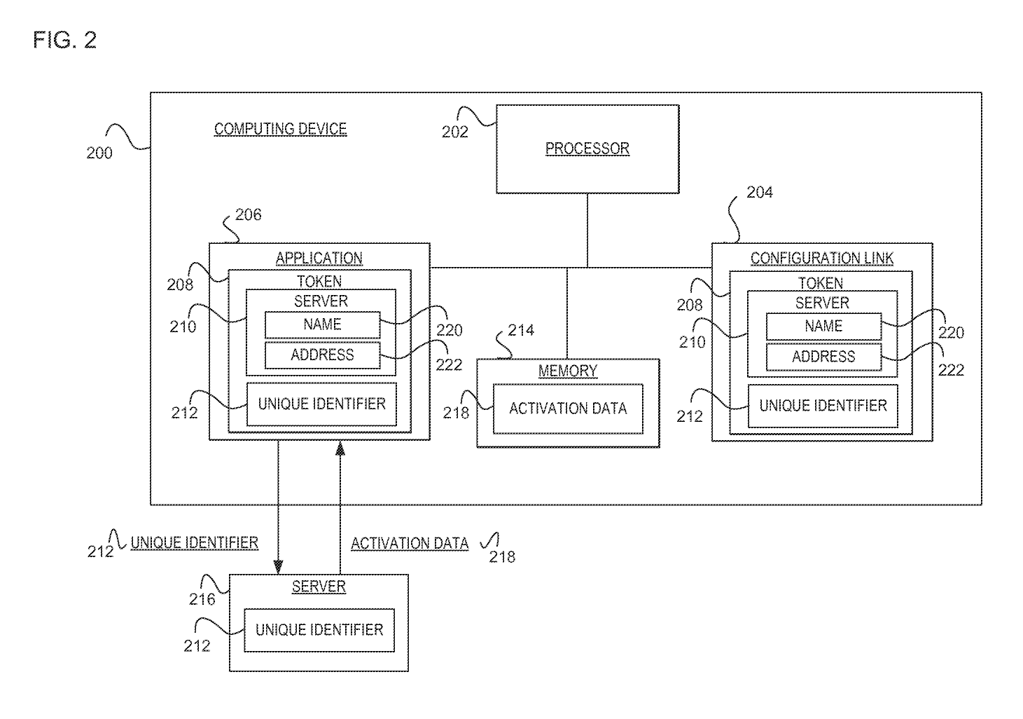

FIG. 2 is a block diagram of an example computing device 200 including a processor 202 to select a configuration link 204 and launch an application 206. The application 206 receives a token 208 including a server 210 with at least a server name 220 and/or server address 222, and a unique identifier 212. The application 206 transmits the unique identifier 212 to the server 216. The server 216, having generated the unique identifier 212 authenticates 212 and transmits the activation data 218 which may be stored on a memory 214 on the computing device 200. The computing device 200 may be similar in functionality and structure to computing device 100 of FIG. 1.

The processor 202 launches the application 206 based from a selection of the configuration link 204. The processor 202 may be similar in structure and functionality of processor 102 of FIG. 1.

The configuration link 204, once selected, launches the application 206 to receive the token 208. The configuration link 204 may be similar in structure and functionality of the configuration link 104 of FIG. 1.

The application 206, once launched, receives the token 208 associated with the unique identifier 212 and server 210 including at least the server name 220 and/or the server address 222. Additionally, utilizing the server name 220 and/or the server address 222, the application 206 transmits the unique identifier 212 to the server 216. The application 206 may be similar in structure and functionality of the application 106 of FIG. 1.

The token 208 includes the unique identifier 212 and the server 210 with at least the server name 220 and/or the server address 222. Once the application 206 is launched, the application 206 may receive the token 208 from the server 216 or as part of the configuration link 204. In another embodiment, the token 208 may be encrypted for the application to decrypt as seen in later figures. The token 208 may be similar in structure and functionality of the token 108 of FIG. 1.

The server 210 is data that identifies and/or references the server 216. Including this data in the token 208 received by the application 206, a user need not input the server 216 properties to configure the application 206 to print. The server 210 includes at least one of the server name 220 and/or the server address 222 in order to identify the server 216. The server name 220 is name space used for the application 204 to identify and locate the server 216. Embodiments of the server name 220 include the domain name, host name, or other name capable of identifying and locating the server 216. The server address 222 is a numerical label (i.e., IP address) assigned to the server 216 for identification and location purposes. In another embodiment, the server name 220 and the server address 222 are server data used to identify and locate the server 216. In this embodiment, since the server data is used to identify and locate the server 216, the server data is considered associated with the server 216.

The unique identifier 212 is generated at the server 216 and is transmitted back to the server 216 by the application 206 for authentication. The unique identifier 212 may be generated at the server 216 and included in the token 208 that may be sent from the server 216 to the application 206 once the configuration link 204 has been selected. The unique identifier 212 may be similar in structure and functionality of the unique identifier 112 of FIG. 1.

The server 216 communicates with the application 206 to receive the unique identifier 212 for authentication and transmits the activation data 218 to the application 206. In one embodiment, the server 216 generates the unique identifier 212. In this embodiment, a set of instructions and/or code is used at the server 216 to generate the unique identifier 212. The server 216 may be similar in structure and functionality of the server 116 of FIG. 1.

The activation data 218 is transmitted from the server 216 once the unique identifier 212 has been authenticated. In one embodiment, the activation data 218 may include policy restrictions placed on the computing device 200 by an administrator of the server 216. The activation data 218 may be similar in structure and functionality of the activation data 118 of FIG. 1.

The memory 214 stores the activation data 218 received from the server 216. Storing the activation data 218, allows data to be transmitted to the server 216 as further authentication for the application 206 to print rather than needing to reconfigure the application 206. This further enables the user of the computing device 200 to submit further print jobs to the server 216. Embodiments of the memory 214 include a local memory, storage, memory buffer, cache, non-volatile memory, random access memory (RAM), an Electrically Erasable Programmable Read-Only memory (EEPROM), storage drive, a Compact Disc Read-Only Memory (CDROM), or other memory device capable of storing the activation data 218.

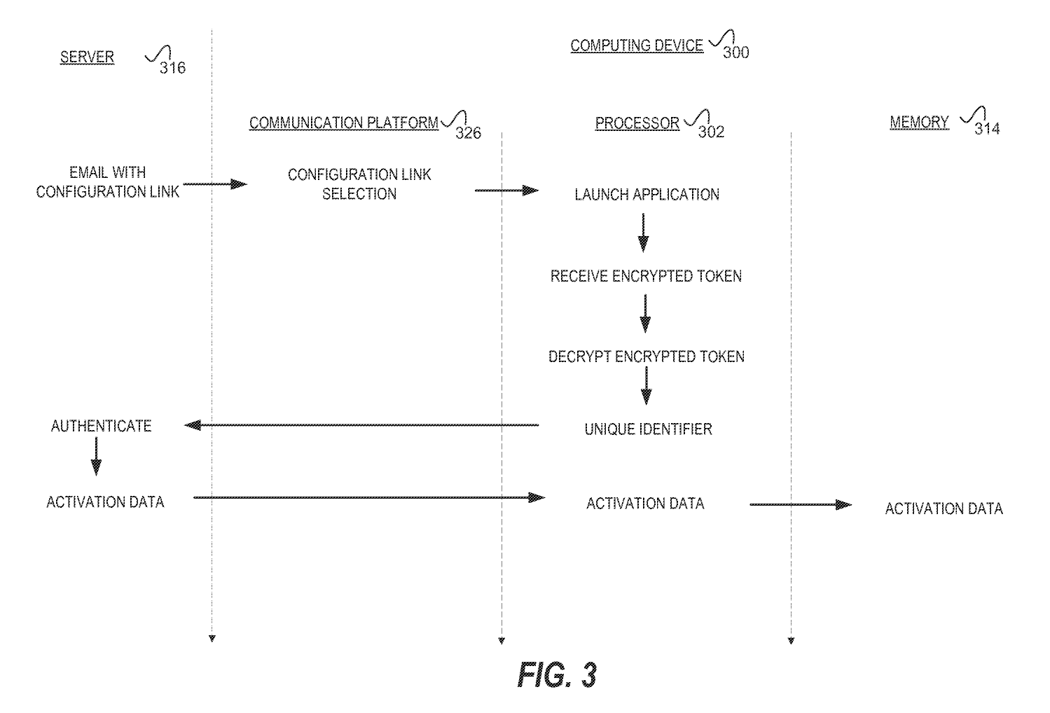

FIG. 3 depicts communication between a server 316 and a computing device 300 including components: a communication platform 326, a processor 302, and a memory 314. The computing device 300 may be similar in structure and functionality of computing devices 100 and 200 of FIG. 1 and FIG. 2, respectively. The server 316 includes the structure and functionality as the server 116 and 216 in FIG. 1 and FIG. 2, respectively.

The server 316 transmits an email with a configuration link to the communication platform 326. In this embodiment, the server 316 may transmit the configuration link based on an administrator specifying a list of email addresses. Each of the email addresses may be associated with computing devices such as the computing device 300 to configure and authenticate an application on each device 300 for printing. The server 316 may also generate a unique identifier which is transmitted by the computing device 300 for authentication. In generating the unique identifier, the server 316 creates the token that may be received by an application operated by processor 302.

The communication platform 326 receives the email with the configuration link and based on a selection of this configuration link, a code and/or instruction may be transmitted to the processor 302 to launch the application. The configuration link selection occurs at the communication platform 326 by a user-initiated response. Embodiments of the communication platform 326 include a network interface, network communication, or other communication network that is suitable to connect the computing device 300 to the server 326. As such, the communication platform may include a wireless local area network, wireless radio, Bluetooth, or other wired or wireless communication to communicate with the server 316.

The processor 302 launches the application once the configuration link has been selected at the communication platform 326. The processor 302 may be similar in structure and functionality of the processor 102 and 202 of FIG. 1 and FIG. 2, respectively. The processor 302 loads and executes instructions to launch and operate the application that enable the computing device 300 to carry out a task. As such, the processor 302 includes the application. Once the application has been launched, the application receives an encrypted token. In one embodiment, the encrypted token may be transmitted by the server 316 once the application has been launched by the processor 302. In this embodiment, the application may communicate with the server 316 to obtain the encrypted token. In another embodiment, the encrypted token may be included as part of the email and transmitted by the communication platform 326 to the processor 302.

Once receiving the encrypted token, the application may be decrypted using a decryption technique specific to the application and/or computing device 300. For example, the application may decrypt the encrypted token using a key specific to the application. The decrypted token includes a unique identifier used for authentication at the server 316 and a server data used to identify and locate the server 316.

The unique identifier from the decrypted token is transmitted to the server 316 while the server data from the decrypted token is used to identify the server 316 to transmit the unique identifier.

The server 316 receives the unique identifier from the application for authentication. The server 316 establishes whether the unique identifier received from the application as genuine. In one embodiment, the server 316 generates the unique identifier, thus the server 316 may store this unique identifier for comparison to determine the authenticity. After authenticating the unique identifier, the server transmits the activation data to the application. The application receives the activation data and transmits this data to the memory 314. The memory 314 receives the activation data from the server 316 to store. The memory 314 may be similar in structure and functionality of the memory 214 of FIG. 2.

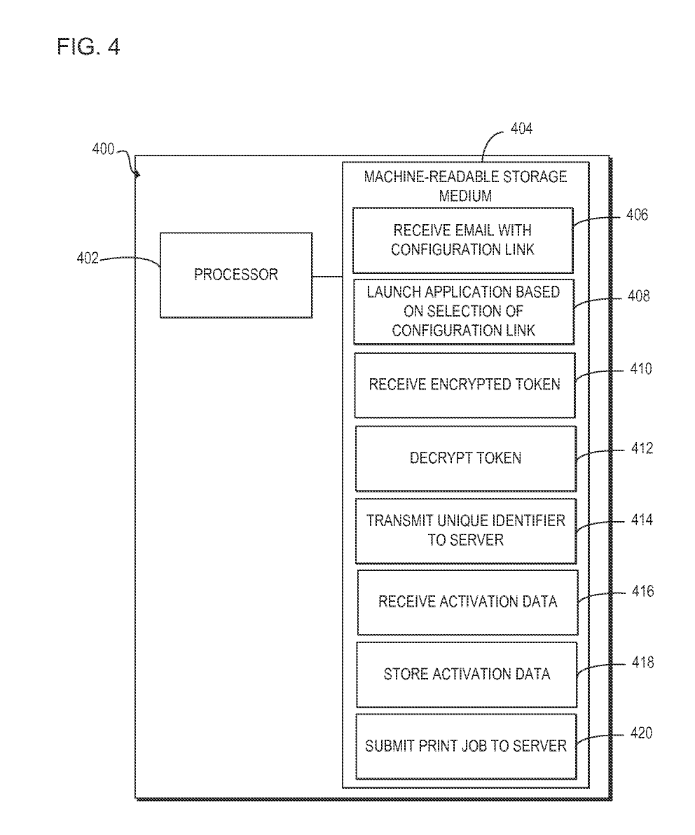

FIG. 4 is a block diagram of an example computing device 400 for receiving an email with a configuration link and storing activation data. Although the computing device 400 includes processor 402 and machine-readable storage medium 404, it may also include other components that would be suitable to one skilled in the art. For example, the computing device 400 may include memory 214 as in FIG. 2. Additionally, the computing device 400 may be similar in structure and functionality of the computing devices 100, 200, and 300 as set forth in FIG. 1, FIG. 2, and FIG. 3, respectively.

The processor 402 may fetch, decode, and execute instructions 406, 408, 410, 412, 414, 416, 418, and 420. Processor 402 may be similar in functionality and structure of the processor 102, 202, and 302 as above in connection with FIG. 1, FIG. 2, and FIG. 3, respectively. Specifically, the processor 402 executes: receive email with a configuration link instructions 406, launch an application based on a selection of the configuration link instructions 408, receive an encrypted token instructions 410, decrypt the encrypted token instructions 412, transmit a unique identifier to a server instructions 414, receive activation data from the server instructions 416, store the activation data instructions 418, and submit a print job to the server instructions 420.

The machine-readable storage medium 404 may include instructions 406, 408, 410, 412, 414, 416, 418, and 420 for the processor 402 to fetch, decode, and execute. The machine-readable storage medium 404 may be an electronic, magnetic, optical, memory, storage, flash-drive, or other physical device that contains or stores executable instructions. Thus, the machine-readable storage medium 404 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 404 may include an application and/or firmware which can be utilized independently and/or in conjunction with the processor 402 to fetch, decode, and/or execute instructions of the machine-readable storage medium 404. The application and/or firmware may be stored on the machine-readable storage medium 404 and/or stored on another location of the computing device 400.

Instructions 406 include the computing device 400 receiving an email with a configuration link associated with a token from a server. The token is further associated with a server data and the unique identifier. In one embodiment of instructions 406, the server identified by the server data may send the configuration link to a list of computing devices to configure and authenticate a printing application. In this embodiment, an administrator of the server may decide which printing applications associated with their respective computing devices should be configured and authenticated. Further, in this embodiment, enabling the administrator to decide which respective computing devices to configure and authenticate provides security and control. Other embodiments of instructions 406 include transmitting a communication including the configuration link from the server to the computing device 400. The communication may include a text message, personal message, and/or instant message.

Instructions 408 include the processor 402 to launch the application based on a selection of the configuration link received at instructions 406. The configuration link includes an instruction and/or code for the processor 402 to launch the application. In another embodiment of instructions 408, the configuration link is selected by a user-initiated action, such as clicking on a link or hovering above the link. Launching the application based on the selection of the configuration link allows the configuration and authentication of the application to occur on the background of the computing device 400 without user input. In this aspect, the application is automatically configured and authenticated to the server as this requires no manual configuration of the application.

Instructions 410 include the application receiving an encrypted token associated with a server data and a unique identifier. The server data identifies the server so the application may transmit the unique identifier for authentication. In one embodiment of instructions 410, the encrypted token is transmitted to the application by the server, in another embodiment of instructions 410, the encrypted token is obtained by the application as part of the configuration link received at instructions 406. In the prior embodiment, the encrypted token may be created at the server. For example, the server may generate the unique identifier and server data to include in the token and as such, may encrypt the token at the server prior to transmission to the application. In a further embodiment of instructions 410, the application may receive the encrypted token simultaneously as the processor launches the application at instructions 408, while in another embodiment of instructions 408, the application receives the encrypted token once the application has launched at instructions 408.

Instructions 412 include the application decrypting the encrypted token. In one embodiment, the encrypted token may be decrypted using a decryption technique local to the application, while in another embodiment, the encrypted token may be decrypted using a decryption technique local to the computing device 400. In keeping with the previous example, the encrypted token transmitted to the application from the server, the application may have a decryption key used to decrypt the token. Decrypting the token, the application obtains the server data and the unique identifier. Further, by decrypting the token using a decryption technique local to the application and/or computing device 400 provides additional security feature to prevent unauthorized computing devices from configuring the application.

Instructions 414 include transmitting the unique identifier to the server associated with the server data for authentication. The server data may include at least one of the server name and/or the server address. The server data is used to identify and locate which server to transmit the unique identifier for authentication. The server authenticates the unique identifier by establishing the unique identifier as genuine.

Instructions 416 include receiving activation data from the server once the server authenticates the unique identifier at instructions 414. In one embodiment, the activation data may include a policy restriction. The policy restriction is one or more policy limitations to constrain the computing device 400. For example, the policy restriction may restrict the computing device 400 for printing specific file types, such as spreadsheet or word processing document. As a further example, the policy restriction may restrict the computing device 400 to specific printers authorized by the server. Further, in these examples, the policy restriction may be specific to the user of the computing device 400. In further embodiment of instructions 416, the server may disable the application on the computing device 400 if the unique identifier is not authenticated.

Instructions 418 include storing the activation data received from the server on a memory within the computing device 400. Storing the activation data on the memory of the computing device 400, the activation data may be used as further authentication from the application to the server. For example, each time a print job may be submitted to the server, rather than configuring the application each time to print, the application may transmit the activation data to the server. In this example, the application need not be authenticated and configured each time the user desires to print.

Instructions 420 include submitting a print job to the server. In one embodiment, instructions 420 occur after storing the activation data instructions 418, while in another embodiment, instructions 420 may occur prior to storing the activation data instructions 418. Additionally, in the embodiment the application is the printing application, the computing device 400 may already be authorized to print once receiving the activation data. As such, a user of the computing device 400 may desire to print, the computing device 400 will submit the desired print job to the server that transmitted the activation data at instructions 416. Submitting the print job to the server that transmitted the activation data at instructions 418, the server enables the print job on the computing device 400 to various printers in a network.

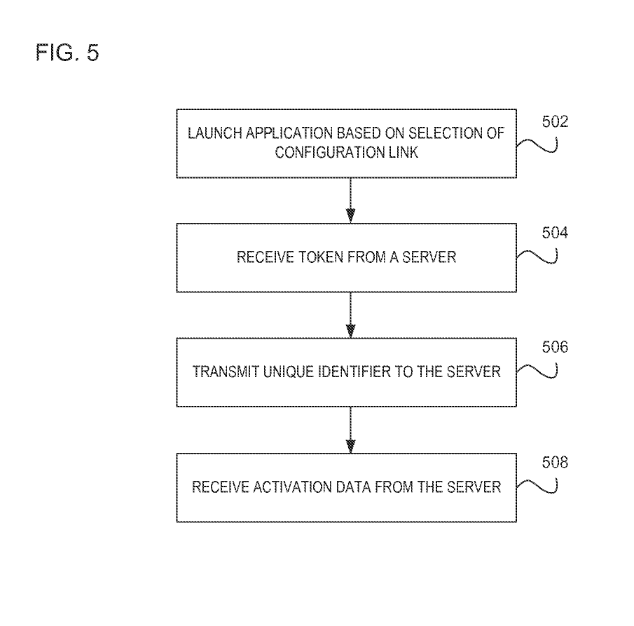

FIG. 5 is a flowchart of an example method performed on a computing device to launch an application based on selecting a configuration link 502 and receive activation data from a server 508. Although FIG. 5 is described as being performed on computing device 100 as in FIG. 1, it may also be executed on other suitable components as will be apparent to those skilled in the art. For example, FIG. 5 may be implemented in the form of executable instructions on a machine readable storage medium, such as machine-readable storage medium 404 in FIG. 4.

At operation 502 a processor on the computing device launches an application based on selection of a configuration link. In another embodiment of operation 502, the computing device may receive a communication with the configuration link from a server.

At operation 504 the application receives a token with a server data and a unique identifier. In one embodiment of operation 504, the application receives the token from the server associated with the server data, while in another embodiment of operation 504, the application receives the token as part of the configuration link. In further embodiment of operation 504, the token received at operation 504 may be an encrypted token. In this embodiment, the encrypted token would need to be decrypted to obtain the unique identifier and the server data.

At operation 506 the application transmits the unique identifier to the server associated with the server data.

At operation 508 the application receives activation data from the server. As a further embodiment of operation 508, the activation data may be stored on a memory of the computing device. In another embodiment of operation 508, the application may submit a print job to the server.

The embodiments described in detail herein provide configuring and authenticating an application based on a selection of a configuration link, thus creating a more-user friendly approach. Additionally, this prevents the user from manually configuring the server properties in the printing application. Further, this allows the printing application to be configured on varying mobile devices provided by various network providers.

We claim:

1. A computing device comprising:
a processor to:
launch an application based on a selection of a configuration link, the configuration link associated with a token;
receive the token by the application, the token associated with a server and unique identifier;
transmit the unique identifier from the application to the server associated with the token; and
receive an activation data based on an authentication of the unique identifier.

2. The computing device of claim 1 further comprising:
a memory to store the activation data from the server.

3. The computing device of claim 1 further comprising:
a communication platform to receive an email with a configuration link from the server.

4. The computing device of claim 1 wherein the token received by the application is an encrypted token and the processor is additionally to:
decrypt the encrypted token.

5. The computing device of claim 1 wherein the unique identifier is generated at the server.

6. The computing device of claim 1 wherein the token association with the server includes at least one of a server address and a server name.

7. A non-transitory machine-readable storage medium encoded with instructions executable by a processor of a computing device, the storage medium comprising instructions to:
launch an application based on a selection of a configuration link, the configuration link associated with a token;
receive the token by the application, the token associated with a server data and an unique identifier;
transmit the unique identifier to a server associated with the server data, the unique identifier generated at the server; and
receive an activation data from the server based on an authentication of the unique identifier.

8. The non-transitory machine-readable storage medium of claim 7 wherein the token received by the application is an encrypted token and further comprising instructions to:
decrypt the encrypted token.

9. The non-transitory machine-readable storage medium of claim 7 further comprising instructions to:
receive an email with the configuration link.

10. The non-transitory machine-readable storage medium of claim 7 further comprising instructions to:
store the activation data from the server.

11. The non-transitory machine-readable storage medium of claim 7 wherein the activation data includes a policy restriction.

12. The non-transitory machine-readable storage medium of claim 7, wherein the application is a mobile printing application.

13. The non-transitory machine-readable storage medium of claim 12 further comprising instructions to:
submit a print job to the server.

14. A method executed by a computing device to:
receive an email with a configuration link from a server;
launch an application based on a selection of the configuration link, the configuration link associated with a token;
receive the token by the application from the server, the token associated with a server data and unique identifier, the server data identifying the server;
transmit the unique identifier to the server associated with the server data; and
receive an activation data from the server based on an authentication of the unique identifier.

15. The method of claim 14 wherein the token received by the application includes an encrypted token and the method is further to:
decrypt the encrypted token.
